(19) United States
(12) Patent Application Publication
(10) Pub. No.: US 2026/0264212 A1
(43) Pub. Date: Sep. 10, 2026

(54) HAMMER

(71) Applicant: LU KANG HAND TOOLS INDUSTRIAL CO., LTD., Fuxing Township (TW)

(72) Inventor: YI-KUNG HUNG, Fuxing Township (TW)

(21) Appl. No.: 19/070,501

(22) Filed: Mar. 4, 2025

(51) Int. Cl. B25G 3/34

(52) U.S. Cl. CPC B25G 3/34

(57) ABSTRACT

A hammer has a handle, a first tool head and a second tool head. The handle has a grip portion and a main body portion connected to each other. An extension gap is formed at one end of the main body portion, and an axial hole is provided at the other end. An abutting edge is formed at one end of the first tool head, a fixing aperture is provided on the abutting edge, a first aperture is provided above the first tool head, and the first aperture is conductive with the fixing aperture. The second tool head comprises an axial shaft, a securing section is provided at a side end of the axial shaft, and a second aperture is provided on the securing section.

### BACKGROUND OF THE INVENTION

### Field of the Invention

The present invention relates to a hammer.

### Description of the Related Art

According to the conventional hammer, most of them are shown in FIG. 11. The hammer 60 mainly comprises a hammer head 61 and a handle 62 connected to each other. The hammer head 61 has a first end 611 and a second end 612, so that the hammer 60 can be used for striking at least at the first end 611.

However, the above conventional structure still has the following problems in practical application: first, the hammer head 61 and the handle 62 of the hammer 60 are integrally forged with metal such as iron or steel, so the overall weight is heavy; second, the hammer 60 is heavy, so when striking, a large reaction force will be generated and fed back to the hand (see FIG. 9) , so that the user is easily hurt or injured by the hammer 60 when holding the hammer 60 and striking, and the safety and comfort of use are poor; third, the hammer head 61 and the handle 62 are integrally connected, so when making a hammer 60 with different functions, the entire mold needs to be re-made, which is costly and difficult to produce.

Therefore, it is desirable to provide a hammer to mitigate and/or obviate the aforementioned problems.

### SUMMARY OF THE INVENTION

An objective of present invention is to provide hammer, which is capable of improving the above-mention problems.

### SUMMARY OF THE DISCLOSURE

In order to achieve the above-mentioned objective, a hammer has a handle, a first tool head and a second tool head. The handle has a grip portion and a main body portion connected to each other. An extension gap is formed at one end of the main body portion, and an axial hole is provided at the other end. An abutting edge is formed at one end of the first tool head, a fixing aperture is provided on the abutting edge, a first aperture is provided above the first tool head, and the first aperture is conductive with the fixing aperture. The second tool head comprises an axial shaft, a securing section is provided at a side end of the axial shaft, and a second aperture is provided on the securing section.

Other objects, advantages, and novel features of invention will become more apparent from the following detailed description when taken in conjunction with the accompanying drawings.

### BRIEF DESCRIPTION OF THE DRAWINGS

FIG. 1 is a three-dimensional combination drawing of a preferred embodiment of

### The Present Invention.

FIG. 2 is an exploded view of the preferred embodiment of the present invention.

FIG. 3 is showing the pressurized state the preferred embodiment of the present invention.

FIG. 4 shows the filling state of the sealing member of the preferred embodiment of the present invention

FIG. 5 is a cross-sectional view of the completed assembly of the preferred embodiment of the present invention.

FIG. 6 shows when the hammer produces slight vibration on the user's hand according to the preferred embodiment of the present invention.

FIG. 7 is the first schematic drawing with installations of different the first tool heads according to the preferred embodiment of the present invention.

FIG. 8 is the second schematic drawing with installations of different the first tool heads according to the preferred embodiment of the present invention.

FIG. 9 is a three-dimensional exploded view of another preferred embodiment of the present invention.

FIG. 10 is a combined cross-sectional view of another preferred embodiment of the present invention.

FIG. 11 is showing a conventional hammer producing a huge vibration to the user's hand.

### DETAILED DESCRIPTION OF THE PREFERRED EMBODIMENT

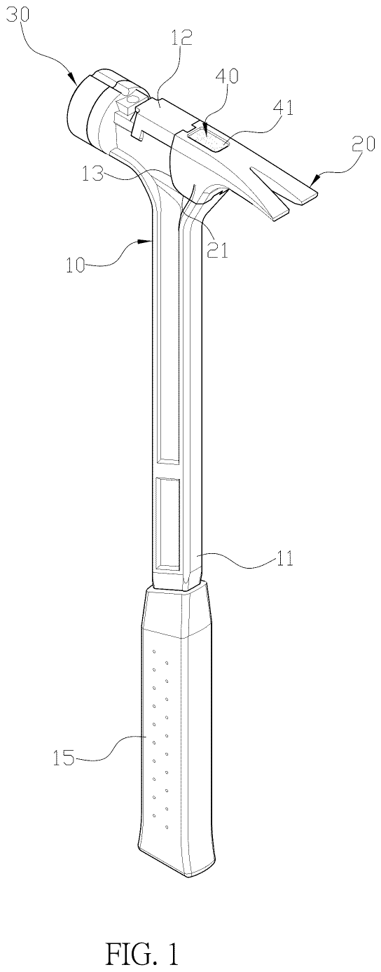

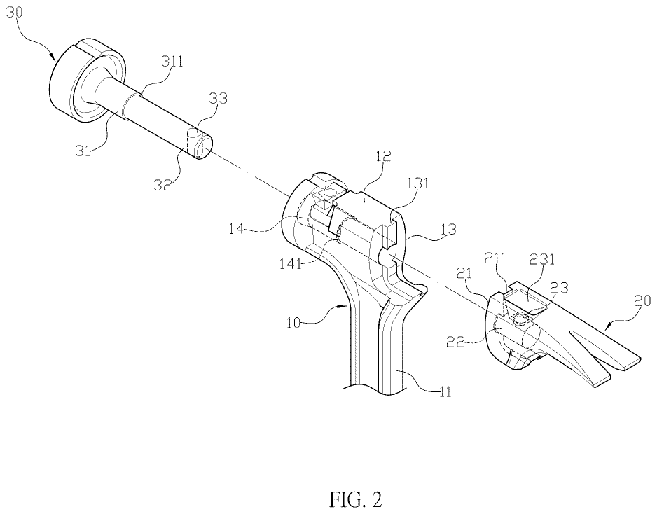

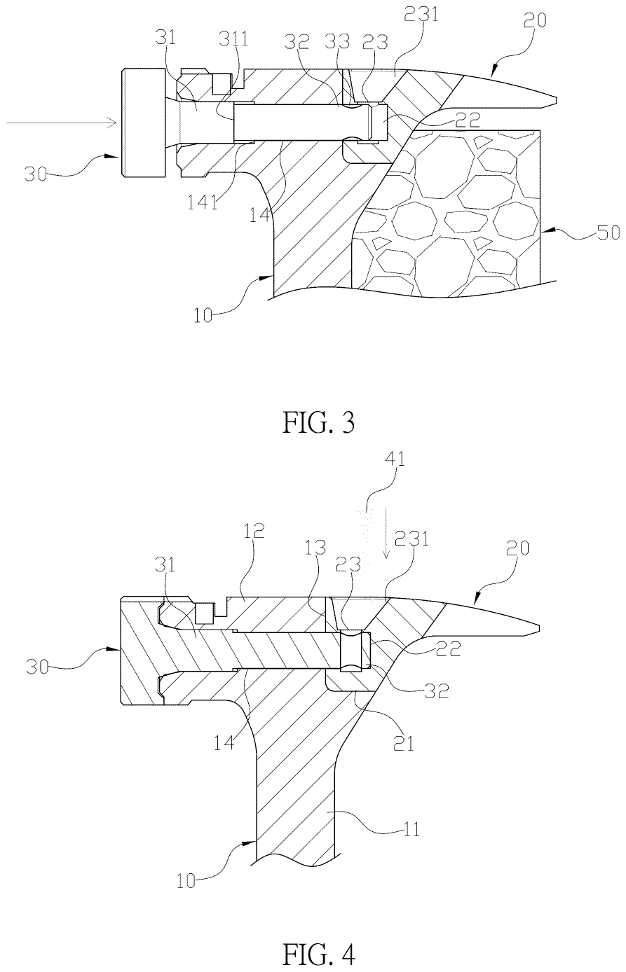

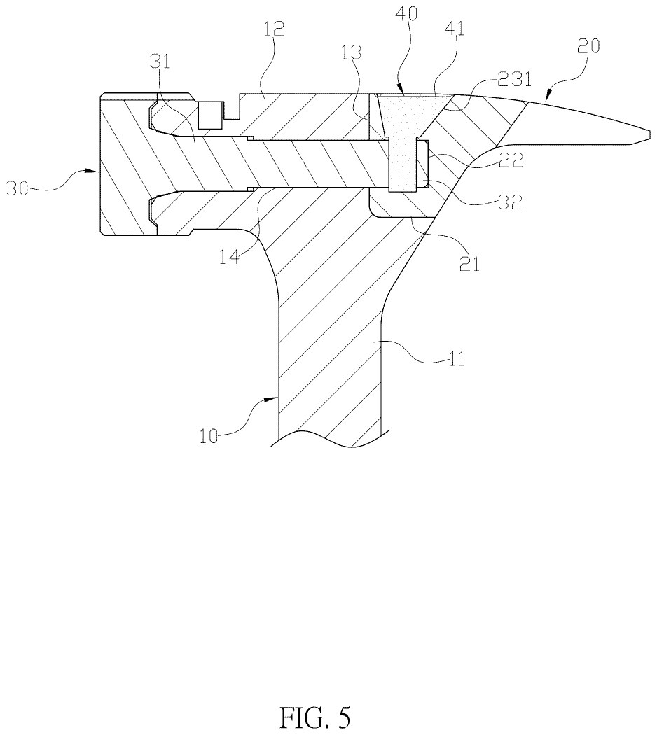

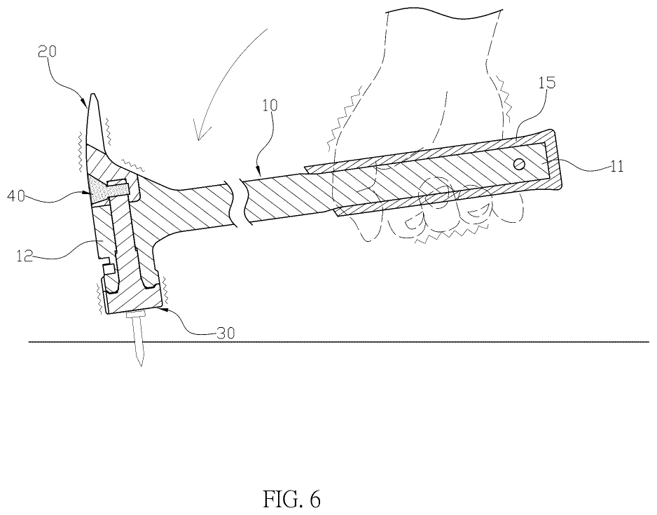

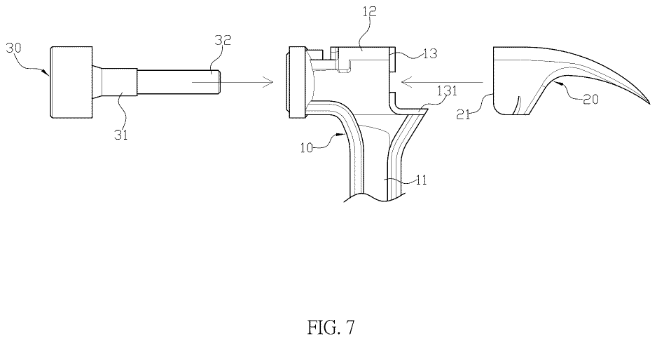

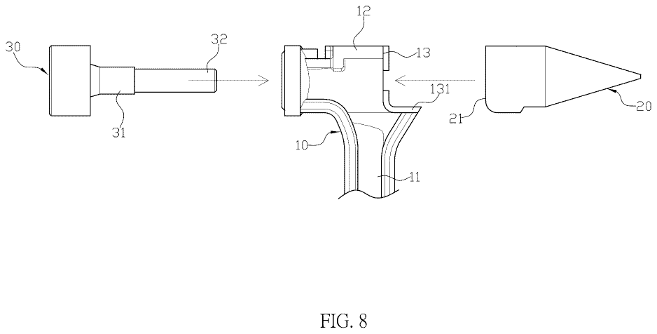

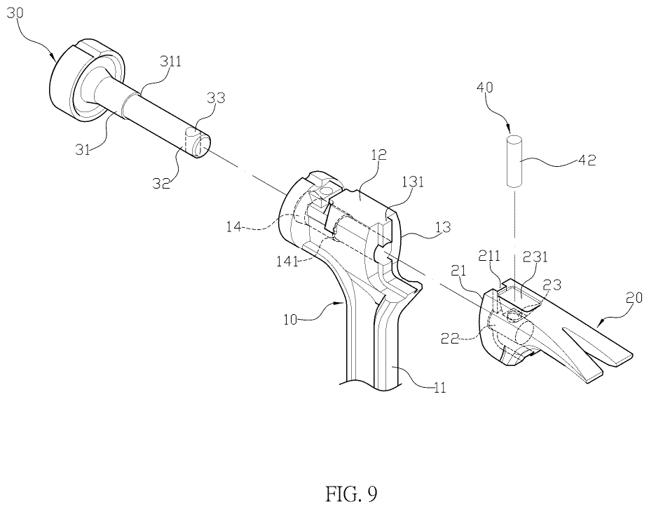

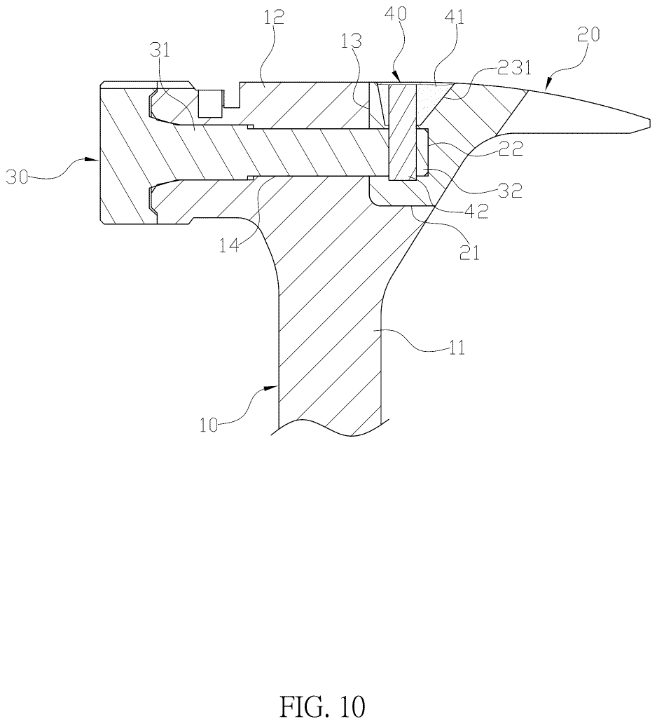

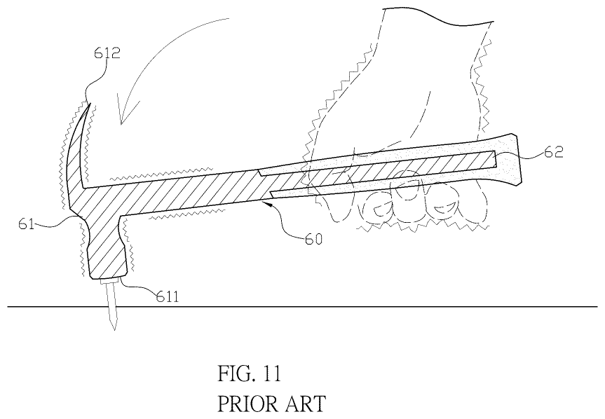

First, please refer to FIGS. 1-5, a hammer comprises: a handle 10, a first tool head 20 and a second tool head 30. The handle 10 is made of a lightweight material different from a material of the first tool head 20 and the second tool head 30, and is extended in a longitudinal direction so that the handle 10 has a grip portion 11 and a main body portion 12 connected to each other. An L-shaped extension gap 13 is provided at one end of the main body portion 12, and an axial hole 14 is provided at another end connected to the extension gap 13, so that the handle 10 can be assembled with the first tool head 20 and the second tool head 30 via the extension gap 13 and the axial hole 14. An L-shaped abutting edge 21 is formed at one end of the first tool head 20, a fixing aperture 22 is disposed on the abutting edge 21, and a first aperture 23 is disposed on the first tool head 20 and connected to the fixing aperture 22. When the abutting edge 21 is supported by a wall defining the extension gap 13, the first tool head 20 can obtain a preliminary positioning on the handle 10 and the fixing aperture 22 is aligned with the axial hole 14. The second tool head 30 has an axial shaft 31 with a securing section 32 at one side, and a second aperture 33 is disposed on the securing section 32. When the axial shaft 31 of the second tool head 30 penetrates into the axial hole 14 and presses the securing section 32 into the fixing aperture 22, the securing section 32 is fixed at the fixing aperture 22 in a tight fit, such that the first tool head 20 and the second tool head 30 can be installed on the handle 10 together. Furthermore, a sealing member 40 is inserted from the first aperture 23 to be combined with the first tool head 20 and the securing section 32, and then preventing the axial shaft 31 from being withdrawn due to vibration.

Additionally, the handle is made of an aluminum alloy.

Also, the first tool head 20 and the second tool head 30 are made of heavy metal such as iron or steel.

Moreover, the grip portion 11 of the handle 10 is covered with a rubber sleeve 15.

Furthermore, at least a first joining portion 131 is provided on a wall surface of the extension gap 13 and at least a second joining portion 211 is disposed on the abutting edge 21. With mutual engagement of the first joining portion 131 and the second joining portion 211, a guiding effect on the fixing aperture 22 of the first tool head 20 during installation can be provided, and also the combined contact area between the main body portion 12 and the first tool head 20 is increased.

In addition, the first joining portion 131 is a guiding rib, and the second joining portion 211 is a guiding groove.

Also, the axial hole 14 is a stepped hole, and the axial shaft 31 is a stepped rod, so that at least one step edge 141, 311 is formed on each of the axial hole 14 and the axial shaft 31.

Additionally, the first tool head 20 is a horn-shaped nail puller, as shown in FIGS. 1-6.

Alternatively, the first tool head 20 is the hammer head of a brick hammer, as shown in FIG. 7.

Again alternatively, the first tool head 20 is a hammer head with a pointed tail hammer, as shown in FIG. 8.

Moreover, the diameter of the fixing aperture 22 is slightly smaller than the outer diameter of the securing section 32, so that the securing section 32 can fit tightly with the fixing aperture 22 after being pressed into the fixing aperture 22. the fixing aperture 22.

Additionally, an opening 231 is formed by expanding a top of the first aperture 23, the sealing member 40 is made by filling with epoxy resin 41, so that the epoxy resin 41 fills in the opening 231, and the first aperture 23 and the second aperture 33 achieve smooth sealing of the opening 231 and the first aperture 23, as shown in FIGS. 4 and 5.

Alternatively, the first aperture 23 is enlarged to form an opening 231, the sealing member 40 is made of epoxy resin 41 and a plug 42, and the plug 42 is first inserted into the first aperture 23 and the second aperture 33, and then the opening 231 is sealed by filling the opening 231 with epoxy resin 41.

Furthermore, the first tool head 20 is first stop on a fixed surface 50, and then a presser forces the securing section 32 of the second tool head 30 into the fixing aperture 22 of the first tool head 20.

Also, the presser is a hydraulic press, and the fixing surface 50 is a fixing fixture mounted on the hydraulic press.

The structure of the above-mentioned specific embodiment can obtain the following benefits: 1. The second tool head 30 is tightly engaged with the fixing aperture 22 of the first tool head 20 via the securing section 32, and after the pressure is removed, the axial shaft 31 can produce a pulling effect on the first tool head 20 and the second tool head 30, so that the first tool head 20 and the second tool head 30 can be more tightly combined on the handle 10 with good combining force. 2. The securing section 32 is pressed into the fixing aperture 22, so it can be more fully stopped to prevent the first tool head 20 and the second tool head 30 from being gradually loosened due to vibration during use. 3. In actual application, whin the second tool head 30 is used for striking, during the striking process, since the overall weight of the hammer is light, it is not only more labor-saving to use, but also can prevent excessive reaction force from being fed back to the hand during striking, and only a slight striking vibration is generated, as shown in FIG. 6, so that the hand can be prevented from being hurt or injured by the shock. 4. The handle 10, the first tool head 20 and the second tool head 30 can be set into different styles according to the required functions, and then assembled at will, so that the production of the hammer can have more possibilities and variability, and the production cost can be reduced to a minimum, and the production is more convenient and easy.

Although the present invention has been explained in relation to its preferred embodiment, it is to be understood that many other possible modifications and variations can be made without departing from the spirit and scope of invention as hereinafter claimed.

What is claimed is:

1. A hammer comprising: a handle, a first tool head and a second tool head; wherein:
the handle is made of a lightweight material different from a material of the first tool head and the second tool head, and is extended in a longitudinal direction so that the handle has a grip portion and a main body portion connected to each other; an extension gap is provided at one end of the main body portion, and an axial hole is provided at another end connected to the extension gap, so that the handle can be assembled with the first tool head and the second tool head via the extension gap and the axial hole; and wherein at least a first joining portion is provided on a wall surface of the extension gap;
an abutting edge is formed at one end of the first tool head, a fixing aperture is disposed on the abutting edge, and a first aperture is disposed on the first tool head and connected to the fixing aperture; the abutting edge is supported by a wall defining the extension gap, so that the first tool head can obtain a preliminary positioning on the handle; and at least a second joining portion is disposed on the abutting edge, wherein with mutual engagement of the first joining portion and the second joining portion, a guiding effect on the fixing aperture of the first tool head during installation can be provided, and also the combined contact area between the main body portion and the first tool head is increased; and wherein the first joining portion is a guiding rib, and the second joining portion is a guiding groove;
the second tool head has an axial shaft with a securing section at one side, and a second aperture is disposed on the securing section; when the axial shaft of the second tool head penetrates into the axial hole and presses the securing section into the fixing aperture, the securing section is fixed at the fixing aperture in a tight fit, such that the first tool head and the second tool head can be installed on the handle together; a sealing member is inserted from the first aperture to be combined with the first tool head and the securing section, preventing the axial shaft from being withdrawn due to vibration.

2. The hammer as claimed in claim 1, wherein the handle is made of an aluminum alloy.

3. The hammer as claimed in claim 1, wherein the extension gap and the abutting edge have matching L shapes.

4. The hammer as claimed in claim 1, wherein the grip portion of the handle is covered with a rubber sleeve.

5. The hammer as claimed in claim 1, wherein the axial hole is a stepped hole, and the axial shaft is a stepped rod, so that at least one step edge is formed on each of the axial hole and the axial shaft.

6. The hammer as claimed in claim 1, wherein an opening is formed by expanding a top of the first aperture, the sealing member is made by filling with epoxy resin, so that the epoxy resin fills in the opening, and the first aperture and the second aperture achieve smooth sealing of the opening and the first aperture.

7. The hammer as claimed in claim 1, wherein the first aperture is enlarged to form an opening, the sealing member is made of epoxy resin and a plug, and the plug is first inserted into the first aperture and the second aperture, and then the opening is sealed by filling the opening with epoxy resin.

8. The hammer as claimed in claim 1, wherein the first tool head is first pressed against a fixed surface, and then a presser forces the securing section of the second tool head into the fixing aperture of the first tool head.
